(19) United States
(12) Patent Application Publication
(10) Pub. No.: US 2026/0241971 A1
(43) Pub. Date: Aug. 20, 2026

(54) MOTORIZED REMOTE-CONTROL TOOLBOX DEVICE

(71) Applicant: Justin Garratt, Staten Island, NY (US)

(72) Inventor: Justin Garratt, Staten Island, NY (US)

(21) Appl. No.: 19/544,091

(22) Filed: Feb. 19, 2026

Related U.S. Application Data
(60) Provisional application No. 63/760,689, filed on Feb. 20, 2025.

(51) Int. Cl. B62B 5/00; B62B 5/06

(52) U.S. Cl. CPC B62B 5/0046; B62B 5/0053; B62B 5/06; B62B 2202/48

(57) ABSTRACT

A motorized remote-control toolbox device is disclosed, which is a cutting-edge solution that combines storage with advanced mobility features. The motorized remote-control toolbox device comprises a motorized base component that is configured to have a conventional toolbox built on it. The base component includes swivel wheels to allow for smooth movement in all directions. The device is powered by a rechargeable battery or plugged into an AC wall outlet via a built-in inverter. The device further comprises a remote-control mounted at the top of the toolbox handle providing forward and reverse directional controls for precise movement. The swivel wheels enhance maneuverability around corners and obstacles, while a built-in power train module and traction motor ensure reliable performance. For added versatility, a controller is mounted at the handle for direct manual operation when needed.

### CROSS-REFERENCE TO RELATED APPLICATION

The present application claims priority to, and the benefit of, U.S. Provisional Application No. 63/760,689, which was filed on Feb. 20, 2025, and is incorporated herein by reference in its entirety.

### FIELD OF THE INVENTION

The present invention relates generally to the field of motorized remote-control toolbox devices. More specifically, the present invention allows easy movement of heavy toolboxes over various terrains, including uneven surfaces. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in motorized remote-control toolbox devices. Generally, tradesmen face significant challenges when transporting their heavy toolboxes. The substantial weight of specialized tools can lead to physical strain, increasing the risk of musculoskeletal injuries, especially when navigating uneven terrain or ramps. This constant manual handling can result in cumulative fatigue, potentially leading to long-term health issues and reduced productivity. The difficulty in maneuvering heavy toolboxes also poses safety risks, as loss of control could result in accidents or damage to tools and surroundings.

Accordingly, there is a demand for an improved motorized remote-control toolbox device that combines storage with advanced mobility features. More particularly, there is a demand for a motorized remote-control toolbox device that provides a toolbox built on a motorized base equipped with swivel wheels for smooth movement in all directions.

Therefore, there exists a long-felt need in the art for a motorized remote-control toolbox device that allows easy movement of heavy toolboxes, including uneven surfaces. There is also a long-felt need in the art for a motorized remote-control toolbox device that minimizes the risk of injuries, fatigue, and potential cardiac implications associated with manually moving heavy toolboxes. Further, there is a long-felt need in the art for a motorized remote-control toolbox device that enables tradesmen to quickly and effortlessly relocate their tools, saving time and energy. Moreover, there is a long-felt need in the art for a device that reduces the likelihood of accidents caused by overexertion or loss of control when moving heavy toolboxes. Further, there is a long-felt need in the art for a motorized remote-control toolbox device that provides convenience with a remote-control operation that allows for precise movement with minimal direct physical contact. Finally, there is a long-felt need in the art for a motorized remote-control toolbox device that can also provide direct manual operation when needed.

The subject matter disclosed and claimed herein, in one embodiment thereof, comprises a motorized remote-control toolbox device. The device is a cutting-edge solution that combines storage with advanced mobility features. The motorized remote-control toolbox device comprises a motorized base component that is configured to have a conventional toolbox built on it. The base component includes swivel wheels to allow for smooth movement in all directions. The device is powered by a rechargeable battery or plugged into an AC wall outlet via a built-in inverter. The device further comprises a remote-control mounted at the top of the toolbox handle, providing forward and reverse directional controls for precise movement. The swivel wheels enhance maneuverability around corners and obstacles, while a built-in power train module and traction motor ensure reliable performance. For added versatility, a controller is mounted at the handle for direct manual operation when needed.

In this manner, the motorized remote-control toolbox device of the present invention accomplishes all of the foregoing objectives and provides users with a device that allows easy movement of heavy toolboxes over various terrains. The device is a motorized base component that includes a toolbox built on it. The device is controlled by a remote-control or direct manual operation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized remote-control toolbox device. The device is a cutting-edge solution that combines storage with advanced mobility features. The motorized remote-control toolbox device comprises a motorized base component that is configured to have a conventional toolbox built on it. The base component includes swivel wheels to allow for smooth movement in all directions. The device is powered by a rechargeable battery. The device further comprises a remote-control or a controller for manual operation.

In one embodiment, the motorized remote-control toolbox device allows easy movement of heavy toolboxes over various terrains, including uneven surfaces. The device provides convenience with remote-control operation that allows for precise movement with minimal direct physical contact. The device includes a toolbox built on a motorized base component equipped with swivel wheels, allowing tradesmen to quickly and effortlessly relocate their tools, saving time and energy.

In one embodiment, the motorized remote-control toolbox device comprises a motorized base component that is configured to have a conventional toolbox built on it. Typically, the base component is configured in a rectangular shape to replicate the shape of the toolbox above it, but can be any suitable shape and size as is known in the art, depending on the shape and size of the toolbox to be carried and/or by the users wants and/or needs. Further, the base component may be made from any of a number of possible materials, including lightweight metals. Typically, the base component may range in size from 2 to 4 feet wide, for example, and can be manufactured in varying sizes and shapes, depending on the needs and/or wants of a user.

In one embodiment, the base component comprises a top surface, a bottom surface, a pair of opposing sidewalls, and a pair of opposing front and rear sidewalls, all forming the rectangular configuration. The top surface, the bottom surface, and pair of opposing sidewalls, and the pair of opposing front and rear sidewalls act to form an interior cavity for housing the motor and other electrical components necessary for operations.

In one embodiment, the base component comprises a plurality of wheels. The plurality of wheels may be disposed on the underside of the base component (i.e., the bottom surface) and may allow the motorized remote-control toolbox device to roll in any direction. In other words, the plurality of wheels may rotate, swivel, and pivot, based on a user's preference and/or commands. Specifically, the plurality of wheels may rotate, swivel, and pivot when the motor is activated. The plurality of wheels can be secured to an underside of the base component via any suitable securing means as is known in the art, such as bolts, screws, pins, etc. Further, any suitable wheels can be utilized as is known in the art, such as castors, rollers, swivel wheels, etc. In one embodiment, the plurality of wheels are rugged, all-terrain wheels which help the device travel around rough terrain during use. Typically, the device comprises four wheels, with one wheel secured to each corner of the bottom surface of the base component. Further, two opposing wheels of the four are directly controlled by the motor to become drive wheels, and the other set of two opposing wheels are followers or free wheels, such that they just rotate and swivel and are controlled by the two drive wheels.

In one embodiment, the base component comprises at least one motor that engages the two drive wheels via a built-in power train module. Preferably, the motor is a traction DC motor powered by a battery, which allows the traction motor to be rechargeable. Typically, the traction motor is an electric motor in communication with the built-in power train module and attached wheels to drive the wheels. Any suitable number of electric motors can be used to drive the device during use, and the motors can be positioned in any suitable place on the device. Further, the motor, the battery, and a controller are all in electrical communication with each other to move the device. Thus, the swivel wheels enhance maneuverability around corners and obstacles, while the built-in power train module and traction motor ensure reliable performance of the motorized remote-control toolbox device.

In one embodiment, the base component comprises a battery for powering the device. The battery is typically positioned in the interior cavity of the base component but can be in any suitable position on the base component or the device as is known in the art. The battery is a rechargeable battery and is typically a USB-C rechargeable battery for powering the electric traction motor. In another embodiment, the base component comprises a built-in inverter, such that the base component includes a plug receptacle, such that an electric cord can be plugged into the device and then the electric cord is plugged into an AC wall outlet, thus offering flexible power options.

In one embodiment, the motorized remote-control toolbox device comprises a remote-control that is mounted at a top of the toolbox handle for easy access. The remote-control provides forward and reverse directional controls for precise movement of the device, as well as an on/off button for turning on and off the device, as needed. Accordingly, the motor, the battery, and the remote-control are all in electrical communication (i.e., wired and/or wireless communication) with each other to move and control the device.

In one embodiment, a controller is mounted at the toolbox handle for direct manual operation of the device, when needed. The controller provides forward and reverse directional controls for movement of the device, as well as an on/off button for turning on and off the device manually. Accordingly, the motor, the battery, and the controller are all in electrical communication (i.e., wired and/or wireless communication) with each other to move and control the device.

In one embodiment, the base component comprises a plurality of exterior lights or reflectors for use in the dark.

In one embodiment, the motorized remote-control toolbox device includes a wireless communications module and additional sensors which would allow the device to pair with a mobile application on a smart device. The mobile device or smart device may be a cellular telephone, a remote-control, or any other device that may have wireless communication capabilities and may be connected to the internet. The mobile or smart device may perform any type of wireless communication, including, but not limited to, WIFI, BLUETOOTH, RFID, NFC, etc. The wireless communication module and additional sensors allow the device to pair with the mobile application on the smart device. Once paired, a user could control the motorized remote-control toolbox device via the mobile application.

In another embodiment, the motorized remote-control toolbox device is manufactured from lightweight metals, such as stainless steel or aluminum, etc., or combinations thereof.

In yet another embodiment, the motorized remote-control toolbox device comprises a plurality of indicia.

In yet another embodiment, a method of allowing easy movement of heavy toolboxes over various terrains is disclosed. The method includes the steps of providing a motorized remote-control toolbox device comprising a motorized base component with wheels configured to have a conventional toolbox built on it. The method also comprises positioning a toolbox on top of the base component. Further, the method comprises removing the remote-control from the toolbox handle. The method also comprises controlling movement of the toolbox and the motorized base component via the remote-control. Finally, the method comprises easily moving the toolbox via the wheeled motorized base component over rough terrain.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the motorized remote-control toolbox device of the present invention in accordance with the disclosed architecture;

FIG. 2 illustrates a perspective view of one embodiment of the motorized remote-control toolbox device of the present invention showing the base component separated from the toolbox in accordance with the disclosed architecture;

FIG. 3 illustrates a perspective view of one embodiment of the motorized remote-control toolbox device of the present invention showing the plug receptacle which can then be plugged into an AC wall outlet in accordance with the disclosed architecture;

FIG. 4 illustrates a perspective view of one embodiment of the motorized remote-control toolbox device of the present invention showing the internal components of the base component in accordance with the disclosed architecture;

FIG. 5 illustrates a perspective view of one embodiment of the motorized remote-control toolbox device of the present invention showing the remote-control and the controller positioned on the handle of the toolbox in accordance with the disclosed architecture; and

FIG. 6 illustrates a flowchart showing the method of allowing easy movement of heavy toolboxes over various terrains in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a motorized remote-control toolbox device that allows easy movement of heavy toolboxes, including uneven surfaces. There is also a long-felt need in the art for a motorized remote-control toolbox device that minimizes the risk of injuries, fatigue, and potential cardiac implications associated with manually moving heavy toolboxes. Further, there is a long-felt need in the art for a motorized remote-control toolbox device that enables tradesmen to quickly and effortlessly relocate their tools, saving time and energy. Moreover, there is a long-felt need in the art for a device that reduces the likelihood of accidents caused by overexertion or loss of control when moving heavy toolboxes. Further, there is a long-felt need in the art for a motorized remote-control toolbox device that provides convenience with a remote-control operation that allows for precise movement with minimal direct physical contact. Finally, there is a long-felt need in the art for a motorized remote-control toolbox device that can also provide direct manual operation when needed.

The present invention, in one exemplary embodiment, is a novel motorized remote-control toolbox device. The motorized remote-control toolbox device comprises a motorized base component that is configured to have a conventional toolbox built on it. The base component includes swivel wheels to allow for smooth movement in all directions. The device is powered by a rechargeable battery or plugged into an AC wall outlet via a built-in inverter. The device further comprises a remote-control mounted at the top of the toolbox handle, providing forward and reverse directional controls for precise movement. The swivel wheels enhance maneuverability around corners and obstacles, while a built-in power train module and traction motor ensure reliable performance. For added versatility, a controller is mounted at the handle for direct manual operation when needed. The present invention also includes a novel method of allowing easy movement of heavy toolboxes over various terrains. The method includes the steps of providing a motorized remote-control toolbox device comprising a motorized base component with wheels configured to have a conventional toolbox built on it. The method also comprises positioning a toolbox on top of the base component. Further, the method comprises removing the remote-control from the toolbox handle. The method also comprises controlling movement of the toolbox and the motorized base component via the remote-control. Finally, the method comprises easily moving the toolbox via the wheeled motorized base component over rough terrain.

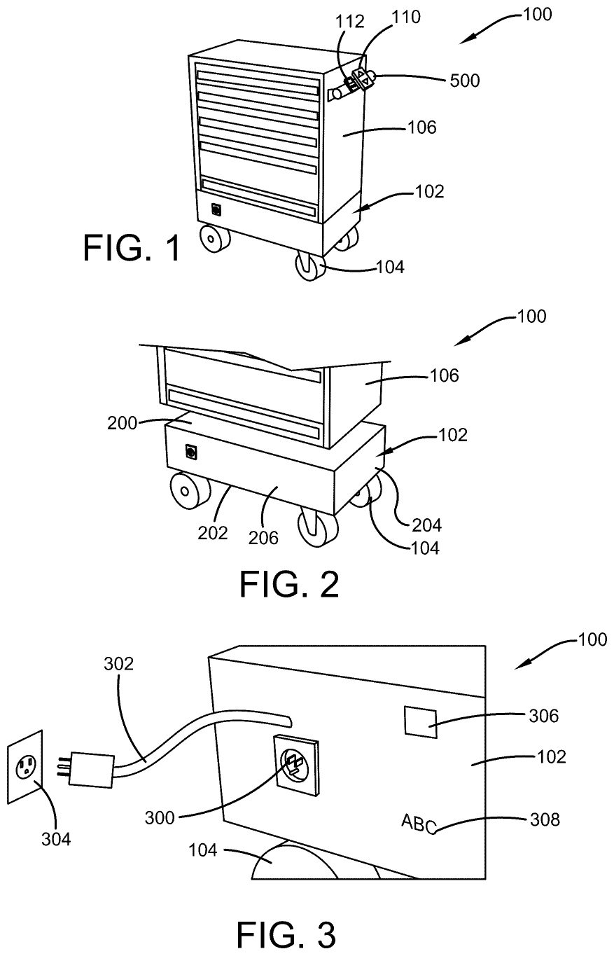

Referring initially to the drawings, FIG. 1 illustrates a perspective view of one embodiment of the motorized remote-control toolbox device 100 of the present invention. In the present embodiment, the motorized remote-control toolbox device 100 is an improved motorized remote-control toolbox device 100 that provides a user with a cutting-edge solution that combines storage with advanced mobility features. Specifically, the motorized remote-control toolbox device 100 comprises a base component 102 with wheels 104, configured to have a conventional toolbox 106 built on it. The device 100 is powered by a rechargeable battery 108. The device 100 further comprises a remote-control 110 or a controller 112 for manual operation.

Generally, the motorized remote-control toolbox device 100 allows easy movement of heavy toolboxes 106 over various terrains, including uneven surfaces. The device 100 provides convenience with remote-control operation that allows for precise movement with minimal direct physical contact. The device 100 includes a toolbox 106 built on a motorized base component 102 equipped with swivel wheels 104, allowing tradesmen to quickly and effortlessly relocate their tools, saving time and energy.

Further, the motorized remote-control toolbox device 100 comprises a motorized base component 102 that is configured to have a conventional toolbox 106 built on it. Typically, the base component 102 is configured in a rectangular shape to replicate the shape of the toolbox 106 above it but can be any suitable shape and size as is known in the art, depending on the shape and size of the toolbox 106 to be carried and/or by the users wants and/or needs. Further, the base component 102 may be made from any of a number of possible materials, including lightweight metals. Typically, the base component 102 may range in size from 2 to 4 feet wide, for example, and can be manufactured in varying sizes and shapes, depending on the needs and/or wants of a user.

As shown in FIG. 2, the base component 102 comprises a top surface 200, a bottom surface 202, a pair of opposing sidewalls 204, and a pair of opposing front and rear sidewalls 206, all forming the rectangular configuration. The top surface 200, the bottom surface 202, and pair of opposing sidewalls 204, and the pair of opposing front and rear sidewalls 206 act to form an interior cavity 208 for housing the motor 210 and other electrical components necessary for operations.

Further, the base component 102 comprises a plurality of wheels 104. The plurality of wheels 104 may be disposed on the underside of the base component 102 (i.e., the bottom surface 202) and may allow the motorized remote-control toolbox device 100 to roll in any direction. In other words, the plurality of wheels 104 may rotate, swivel, and pivot, based on a user's preference and/or commands. Specifically, the plurality of wheels 104 may rotate, swivel, and pivot when the motor 210 is activated. The plurality of wheels 104 can be secured to an underside 202 of the base component 102 via any suitable securing means as is known in the art, such as bolts, screws, pins, etc. Further, any suitable wheels 104 can be utilized as is known in the art, such as castors, rollers, swivel wheels, etc. In one embodiment, the plurality of wheels 104 are rugged, all-terrain wheels which help the device travel around rough terrain during use. Typically, the device 100 comprises four wheels 104, with one wheel 104 secured to each corner of the bottom surface 202 of the base component 102. Further, two opposing wheels 212 of the four are directly controlled by the motor 210 to become drive wheels 212, and the other set of two opposing wheels 214 are followers or free wheels 214, such that they just rotate and swivel and are controlled by the two drive wheels 212.

As shown in FIG. 3, the base component 102 comprises a built-in inverter (not shown), such that the base component 102 includes a plug receptacle 300, such that an electric cord 302 can be plugged into the device 100 and then the electric cord 302 is plugged into an AC wall outlet 304, thus offering flexible power options for the device 100.

In one embodiment, the base component 102 comprises a plurality of exterior lights or reflectors 306 for use in the dark. The lights or reflectors 306 can be any suitable shape or size or number as is known in the art, depending on the needs and/or wants of a user.

In another embodiment, the motorized remote-control toolbox device 100 is manufactured from lightweight metals, such as stainless steel or aluminum etc., or combinations thereof.

In yet another embodiment, the motorized remote-control toolbox device 100 comprises a plurality of indicia 308. The base component 102 of the device 100 may include advertising, a trademark, or other letters, designs, or characters, printed, painted, stamped, or integrated into the base component 102, or any other indicia 308 as is known in the art. Specifically, any suitable indicia 308 as is known in the art can be included, such as, but not limited to, patterns, logos, emblems, images, symbols, designs, letters, words, characters, animals, advertisements, brands, etc., that may or may not be toolbox, wheels, or brand related.

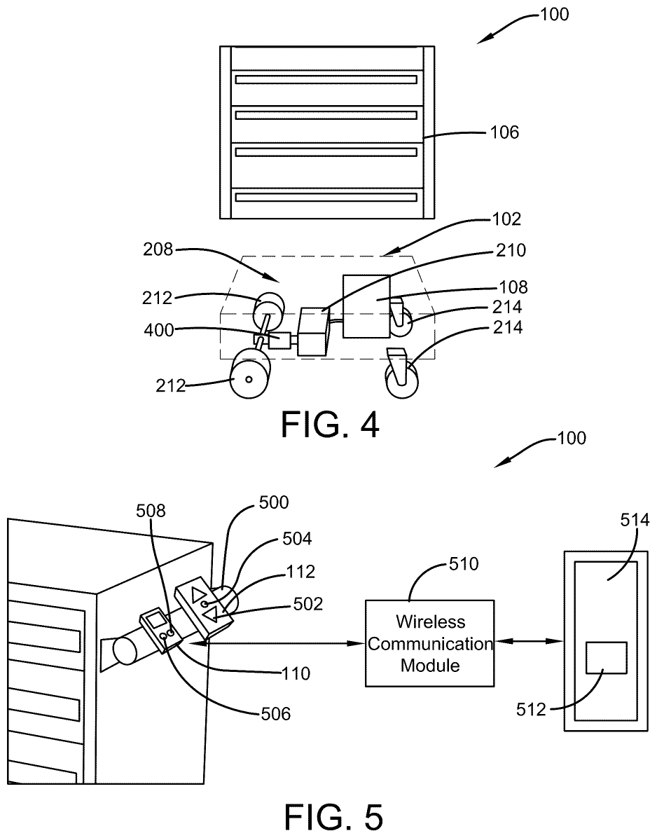

As shown in FIG. 4, the base component 102 comprises a battery 108 for powering the device 100. The battery 108 is typically positioned in the interior cavity 208 of the base component 102, but can be in any suitable position on the base component 102 or the device 100 as is known in the art. The battery 108 is a rechargeable battery and is typically a USB-C rechargeable battery for powering the electric traction motor 210.

The battery 108 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the motorized remote-control toolbox device 100. Throughout this specification, the term “battery” may be used interchangeably to refer to one or more wet or dry cells or batteries of cells in which chemical energy is converted into electricity and used as a source of DC power. References to recharging or replacing the battery 108 may refer to recharging or replacing individual cells, individual batteries of cells, or a package of multiple battery cells, as is appropriate for any given battery technology that may be used. In addition, a rechargeable embodiment of the battery 108 may be recharged using a USB port (not shown), wherein the USB port is a USB-A, USB-B, Micro-B, Micro-USB, Mini-USB, or USB-C port, etc.

Further, the base component 102 comprises at least one motor 210 that engages the two drive wheels 212 via a built-in power train module 400. Preferably, the motor 210 is a traction DC motor powered by a battery 108, which allows the traction motor 210 to be rechargeable. Typically, the traction motor 210 is an electric motor in communication with the built-in power train module 400 and attached wheels 104 to drive the wheels 212. Any suitable number of electric motors 212 can be used to drive the device 100 during use, and the motors 210 can be positioned in any suitable place on the device 100. Further, the motor 210, the battery 108, and a controller 112 are all in electrical communication with each other to move the device 100. Thus, the swivel wheels 104 enhance maneuverability around corners and obstacles, while the built-in power train module 400 and traction motor 210 ensure reliable performance of the motorized remote-control toolbox device 100.

As shown in FIG. 5, the motorized remote-control toolbox device 100 comprises a remote-control 110 that is mounted at a top of the toolbox handle 500 for easy access. The remote-control 110 provides forward and reverse directional controls 502 for precise movement of the device 100, as well as an on/off button 504 for turning on and off the device 100, as needed. Accordingly, the motor 210, the battery 108, and the remote-control 110 are all in electrical communication (i.e., wired and/or wireless communication) with each other to move and control the device 100.

In one embodiment, a controller 112 is mounted at the toolbox handle 500 for direct manual operation of the device 100, when needed. The controller 112 provides forward and reverse directional controls 506 for movement of the device 100, as well as an on/off button 508 for turning on and off the device 100 manually. Accordingly, the motor 210, the battery 108, and the controller 112 are all in electrical communication (i.e., wired and/or wireless communication) with each other to move and control the device 100.

In another embodiment, the motorized remote-control toolbox device 100 includes a wireless communications module 510 and additional sensors which would allow the device 100 to pair with a mobile application 512 on a smart device 514. The mobile device or smart device 514 may be a cellular telephone, a remote-control, or any other device that may have wireless communication capabilities and may be connected to the internet. The mobile or smart device 514 may perform any type of wireless communication, including, but not limited to, WIFI, BLUETOOTH, RFID, NFC, etc. The wireless communication module 510 and additional sensors allow the device 100 to pair with the mobile application 512 on the smart device 514. Once paired, a user could control the motorized remote-control toolbox device 100 via the mobile application 512.

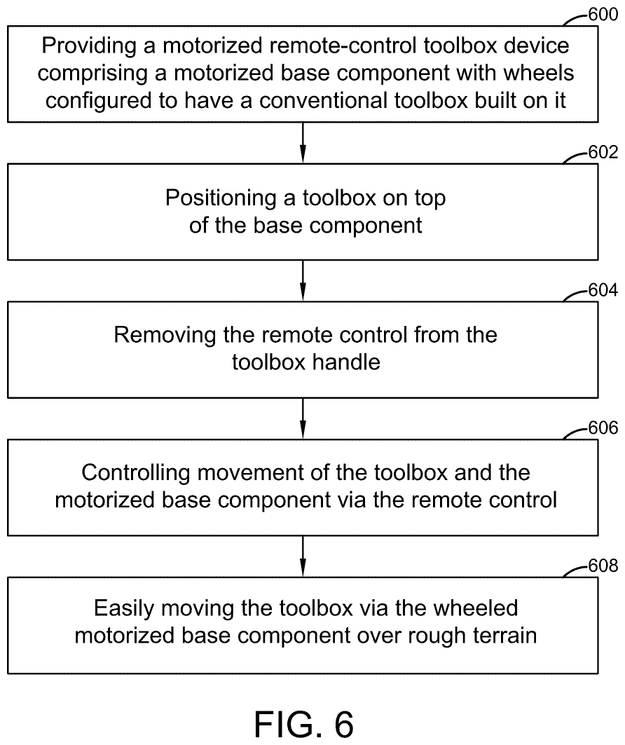

FIG. 6 illustrates a flowchart of the method of allowing easy movement of heavy toolboxes over various terrains. The method includes the steps of at 600, providing a motorized remote-control toolbox device comprising a motorized base component with wheels configured to have a conventional toolbox built on it. The method also comprises at 602, positioning a toolbox on top of the base component. Further, the method comprises at 604, removing the remote-control from the toolbox handle. The method also comprises at 606, controlling movement of the toolbox and the motorized base component via the remote-control. Finally, the method comprises at 608, easily moving the toolbox via the wheeled motorized base component over rough terrain.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “motorized remote-control toolbox device”, “toolbox device”, “motorized remote-control device”, and “device” are interchangeable and refer to the motorized remote-control toolbox device 100 of the present invention.

Notwithstanding the foregoing, the motorized remote-control toolbox device 100 of the present invention can be of any suitable size and configuration as is known in the art without affecting the overall concept of the invention, provided that it accomplishes the above-stated objectives. One of ordinary skill in the art will appreciate that the motorized remote-control toolbox device 100 as shown in FIGS. 1-6 is for illustrative purposes only, and that many other sizes and shapes of the motorized remote-control toolbox device 100 are well within the scope of the present disclosure. Although the dimensions of the motorized remote-control toolbox device 100 are important design parameters for user convenience, the motorized remote-control toolbox device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized remote-control toolbox device that provides a user with a means for moving heavy toolboxes easily, the motorized remote-control toolbox device comprising:
a base component; and
a plurality of wheels;
wherein the base component is configured to have a conventional toolbox built on it;
wherein the plurality of wheels are secured to an underside of the base component; and
further wherein a motor within the base component is powered by a battery to motorize the plurality of wheels and allow easy movement of heavy toolboxes over various terrains.

2. The motorized remote-control toolbox device of claim 1, wherein the base component is configured in a rectangular shape to replicate shape of a conventional toolbox positioned on top of it.

3. The motorized remote-control toolbox device of claim 2, wherein the base component comprises a top surface, a bottom surface, a pair of opposing sidewalls, and a pair of opposing front and rear sidewalls all forming a rectangular configuration.

4. The motorized remote-control toolbox device of claim 3, wherein the top surface, the bottom surface, and the pair of opposing sidewalls, and the pair of opposing front and rear sidewalls act to form an interior cavity for housing the motor and other electrical components necessary for operations.

5. The motorized remote-control toolbox device of claim 4, wherein the plurality of wheels includes four wheels secured to a bottom surface of the base component, with a set of two drive wheels directly controlled by the motor and a set of two free wheels that are controlled by the set of two drive wheels.

6. The motorized remote-control toolbox device of claim 5, wherein the base component comprises a built-in inverter and a plug receptacle for attached an electric cord, to allow the electric cord to be plugged into an AC wall outlet.

7. The motorized remote-control toolbox device of claim 6, wherein the battery is positioned in the interior cavity of the base component and is a rechargeable battery.

8. The motorized remote-control toolbox device of claim 7, wherein the motor is a traction DC motor and engages the set of two drive wheels via a built-in power train module.

9. The motorized remote-control toolbox device of claim 8 further comprising a remote-control that is mounted at a top of a toolbox handle.

10. The motorized remote-control toolbox device of claim 9 wherein the remote-control includes forward and reverse directional controls and an on/off button.

11. The motorized remote-control toolbox device of claim 10 further comprising a controller mounted at the toolbox handle for direct manual operation of the motorized remote-control toolbox device.

12. The motorized remote-control toolbox device of claim 11, wherein the controller includes forward and reverse directional controls and an on/off button.

13. The motorized remote-control toolbox device of claim 12, wherein the motor, the battery, the remote-control, and the controller are all in electrical communication with each other to move and control the motorized remote-control toolbox device.

14. A motorized remote-control toolbox device that provides a user with a means for moving heavy toolboxes easily, the motorized remote-control toolbox device comprising:
a base component configured in a rectangular shape to replicate shape of a conventional toolbox positioned on top of it;
four wheels secured to a bottom surface of the base component, with a set of two drive wheels directly controlled by a motor and a set of two free wheels that are controlled by the set of two drive wheels;
a traction motor; and
a rechargeable battery;
wherein the base component comprises a top surface, a bottom surface, a pair of opposing sidewalls, and a pair of opposing front and rear sidewalls all forming a rectangular configuration with an interior cavity for housing the traction motor and other electrical components necessary for operations;
wherein the traction motor engages the set of two drive wheels via a built-in power train module;
wherein the traction motor within the base component is powered by the rechargeable battery to motorize the set of two drive wheels and allow easy movement of heavy toolboxes over various terrains;
wherein a remote-control is mounted at a top of a toolbox handle to control the traction motor from afar;
wherein a controller is mounted at the toolbox handle for direct manual operation; and
further wherein the traction motor, the rechargeable battery, the remote-control, and the controller are all in electrical communication with each other to move and control the motorized remote-control toolbox device.

15. The motorized remote-control toolbox device of claim 14 further comprising a wireless communications module and additional sensors which allow the motorized remote-control toolbox device to pair with a mobile application on a smart device.

16. The motorized remote-control toolbox device of claim 15, wherein once paired, a user could control the motorized remote-control toolbox device via the mobile application.

17. The motorized remote-control toolbox device of claim 14, wherein the base component comprises a plurality of exterior lights or reflectors for use in dark.

18. The motorized remote-control toolbox device of claim 14, wherein the motorized remote-control toolbox device is manufactured from lightweight metals, such as stainless steel or aluminum, or combinations thereof.

19. The motorized remote-control toolbox device of claim 14 further comprising a plurality of indicia.

20. A method of allowing easy movement of heavy toolboxes over various terrains, the method comprising the following steps:
providing a motorized remote-control toolbox device comprising a motorized base component with wheels configured to have a conventional toolbox built on it;
positioning a toolbox on top of the base component;
removing the remote-control from the toolbox handle;
controlling movement of the toolbox and the motorized base component via the remote-control; and
easily moving the toolbox via the wheeled motorized base component over rough terrain.
